(19) United States
(12) Patent Application Publication
(10) Pub. No.: US 2026/0287764 A1
(43) Pub. Date: Sep. 24, 2026

(54) RADIOMETRIC DETECTOR

(71) Applicant: Endress+Hauser SE+Co. KG, Maulburg (DE)

(72) Inventors: Gerd Bechtel, Steinen (DE); Viraj Chitale, Steinen (DE); Markus Franzke, Schwörstadt-Dossenbach (DE)

(21) Appl. No.: 19/140,099

(22) PCT Filed: Dec. 7, 2023
(86) PCT No.: PCT/EP2023/084668

§ 371 Date: Jun. 17, 2025

(30) Foreign Application Priority Data
Dec. 19, 2022 (DE) 10 2022 133 800.2

(51) Int. Cl. G01T 1/20; G01F 23/288; G01N 9/24

(52) U.S. Cl. CPC G01T 1/20188; G01F 23/2885; G01N 9/24

(57) ABSTRACT

A detector for radiometric measuring systems, whose scintillator and photodiode are compactly dimensioned and optically coupled such that they are optically shieldingly encapsulatable by microelectronic construction and joining technologies. A corresponding, shared encapsulation for the scintillator and semiconductor component, which includes the at least one photodiode, can be provided according to any IC package-type, such as, for example, “Through Hole” or “Surface Mount”. Accordingly, the evaluation signal, which the photodiode produces as a function of the scintillator entering, radioactive radiation intensity, can be tapped, for example, via an output-pin of the encapsulation. Advantageous for the detector is thus its manageability as a conventionally populatable electronic component. This enables modular construction of radioactive measuring systems to adapt with little constructive effort individually to particular fields of application.

The invention relates to a detector for radiometric measuring systems.

In automation technology, especially in process automation, measuring devices, and measuring systems, are often applied to serve for registering and/or influencing process variables. In such case, determined as process variables are, among others, fill level, flow, pressure, temperatures, pH value, redox potential or conductivity. In such case, depending on process variable, mutually differing measuring principles are implemented in the measuring device, or measuring system. Serving for influencing process variables are actuators, for instance valves or pumps, via which the flow of a liquid in a pipeline section or the fill level in a container can be changed. A large number of such measuring devices and measuring systems are manufactured and sold by the Endress+Hauser group of firms.

When, because of harsh conditions, other measuring principles, such as, for example, radar, are not suitable, then, above all, radiometric based measuring systems are applied for fill level measurement. In the case of the radiometric measuring principle, radioactive radiation is utilized. This can be, for example, gamma radiation from a cesium-or cobalt-source. The gamma radiation passes from the source through a container containing a fill substance. After passage through the container, remaining radiation intensity is registered by a corresponding detector of the measuring system. For this, the detector is arranged on the opposite side of the container from the radiation source. Based on the intensity, or power, of the signal entering the detector, the fraction of the radiation originally coming from the radiation source is determined. Based on the transmitted fraction, in turn, the fill level of the fill substance in the container is determined. In such case, the transmitted fraction of the radioactive radiative power after passage through the container cannot be directly detected. Instead, the radioactive radiation is converted in the detector by a suitable material, firstly, into electromagnetic radiation in the optical spectral range. Only then can the radiative power be detected in the detector using a photo receiver, such as a photomultiplier or a photodiode, especially an avalanche-photodiode or a silicon-photomultiplier.

Materials, which have such a conversion property, are referred to as scintillating materials. Among others, organic scintillating materials, such as polystyrene, polyvinyl-toluene, or inorganic, or crystalline, forms, such as thallium doped sodium iodide and gadolinium-aluminum-gallium-garnet (Ld₃Al₂La₃O₁₂), are examples of such materials.

Besides fill level, such measuring systems operating based on the radiometric measuring principle can, after corresponding calibration, also determine the density of the fill substance. Radiometric fill level-and density measurement systems are known from the state of the art. The basic functional principle is described, for example, in EP 2 208 031B1.

Each radiometric measuring system needs to be individually adapted to the process to be observed, especially to a container of the process. This concerns, above all, the detector, since the vertically to be observed region on the container, be it for fill level—or density measurement, must be completely covered by the scintillator of the detector. Depending on process and container-size, the region to be covered can vary greatly.

An object of the invention, therefore, is to provide, in this regard, an individually adaptable measuring system.

The invention achieves the object by a radiometric detector for radiometric measuring systems, comprising:
a scintillator, and
one or more photodiodes optically connected with the scintillator, in order to generate as a function of radioactive radiation intensity entering the scintillator an electrical evaluation signal. In the case of a plurality of photodiodes, such can be arranged, for example, as an array, especially on one semiconductor component. In such case, the photodiode(s) can be, for example, GaAs based avalanche-photodiode(s) or silicon photomultiplier(s) (“SiPM”). In the context of the invention, “photodiode”, thus, includes silicon photomultipliers.

According to the invention, the at least one photodiode and the scintillator are compactly dimensioned and coupled with one another in such a manner such that they are encapsulatable by means of microelectronic construction-and joining technologies. A corresponding shared encapsulation of the detector can in the case of corresponding design additionally guard the scintillator and the photodiode against stray optical radiation. The evaluation signal of the detector can be tapped via an electrical output of the encapsulation. In such case, the encapsulation and the output can be designed according to all types of IC package, such as, for example,
“Through-Hole”
“Surface-Mounted”
“Chip Carrier”
“Pin Grid Array”
“Flat Package”
“Small Outline Integrated Circuit”
“Chip-Scale Package”
“Ball Grid Array”
“Multi-Chip Package” with potted circuit board.

Advantageous for the detector of the invention is its manageability as a conventionally populatable, electronic component. This enables a modular design of radioactive measuring systems, in order to be able to adapt them with little constructive effort individually to particular fields of application.

The building of the detector of the invention can be further facilitated, when the encapsulation is formed by the scintillator and vice versa. This can be realized, for instance, in the case of organic scintillator-materials, which are potted as an encapsulation, for example, by means of injection molding. In order to protect the at least one photodiode against light influences corrupting the radiometric measuring, the scintillator based encapsulation is coated optically nontransparently in this design variant.

The detector of the invention can, moreover, be developed in a form such that the at least one photodiode within the encapsulation is followed by a signal processing unit, which can amplify, filter and/or digitize the evaluation signal. Since, depending on photodiode-type, a DC power supply between 20 V and 95 V is necessary, a high voltage converter can, furthermore, be integrated within the encapsulation for the voltage supply of the photodiode. In such case, a temperature sensor can also be integrated within the encapsulation, such that the high voltage source can be correspondingly controlled as a function of temperature. In this way, it is possible to compensate the temperature-dependence of the photodiode by control means.

In such case, the detector of the invention can be especially compactly encapsulated—, for example, based on a “Chip-Scale-Package”—when the signal processing unit, the high voltage source, and the temperature sensor are designed as integral components of the semiconductor component, which also comprises the photodiode(s).

The detector of the invention can be applied, for example, in computer-tomographic equipment or in radiometric measuring systems of industrial process measurements technology, in order to determine, for example, density, density profile and/or a fill level of a fill substance in a container. Such measuring systems are constructed in the following way:
a radioactive radiation source is placed relative to the container in such a manner that radioactive radiation is transmitted within a defined beam-cone toward the container,
at least one detector of the invention according to one of the above described embodiments is mounted on the opposite side of the container from the radiation source in such a manner that the scintillator of the detector is located, at least partially, in the beam-cone, and
an evaluation unit connected to the at least one detector determines based on the one or more evaluation signals, depending on design of the measuring system, the density, the density profile or the fill level of the fill substance in the container.

In general, understood as “unit” in the context of the invention are, in principle, any electronic circuits, which are provided for the particular application, for example, for measurement signal processing or to serve as an interface. The particular unit can thus, depending on application, comprise corresponding analog circuits for producing, or processing, analog signals. The unit can, however, also comprise digital circuits, such as FPGAs, microcontrollers or storage media in cooperation with corresponding programs. In such case, the program is designed to perform the necessary method steps, or to apply the needed computer operations. In this context, different units can, within the scope of the invention, potentially also use a shared physical memory, or be operated by means of the same physical, digital circuit. On the other hand, it does not matter whether different electronic circuits are arranged within one unit on a shared circuit board or on a plurality, of circuit boards connected together.

Above all for fill level-and for density profile measurements, the measuring system advantageously includes a plurality of cascaded detectors, which are especially arranged lined up vertically above one another at the container. In such case, the detectors can either be populated on a shared circuit board. Or the detectors can be arranged each on a separate circuit board in a separate housing, such that as independent modules they individually complete the measuring system. In the case of computer-tomographic equipment, the detectors of the invention are arranged as an array according to the functional principle of tomography.

The invention will now be explained in greater detail based on the appended drawing, the figures of which show as follows:

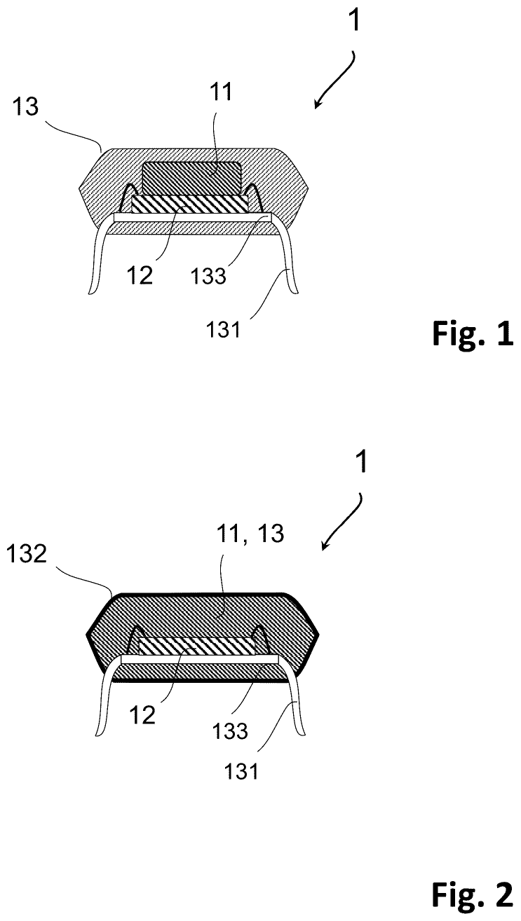

FIG. 1 a cross sectional view of a detector of the invention

FIG. 2 a cross sectional view of the detector in a preferred embodiment,

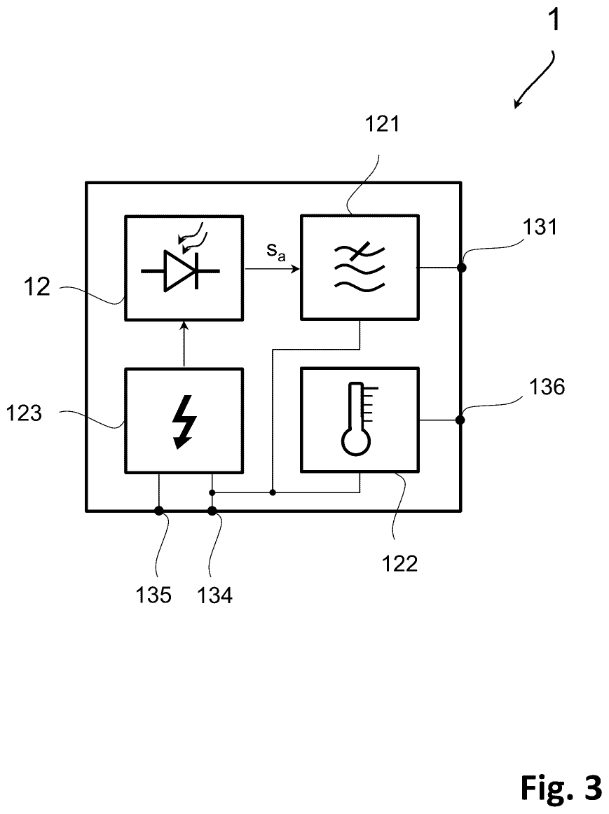

FIG. 3 a block circuit diagram of an embodiment of the detector, and

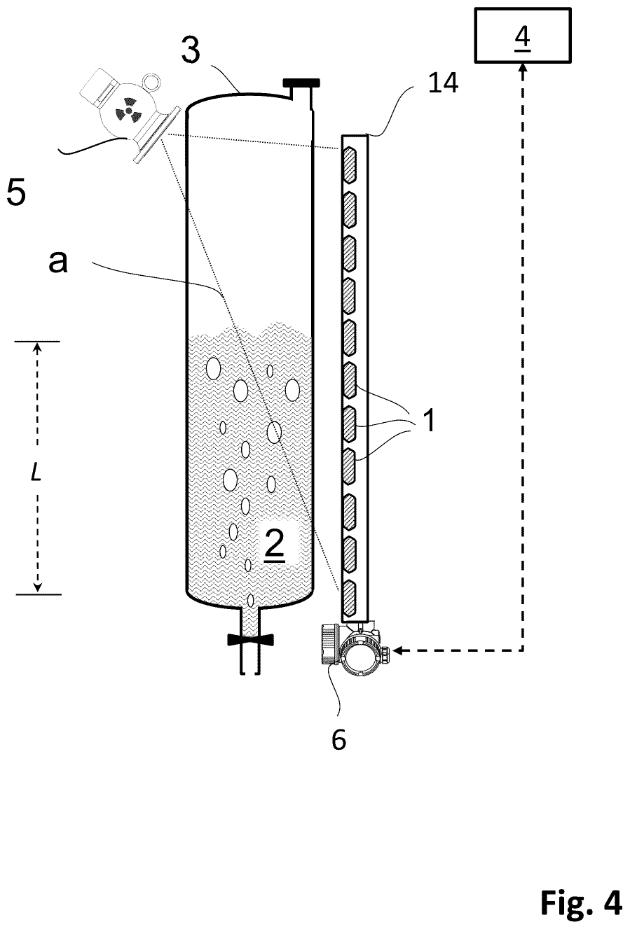

FIG. 4 a radiometric measuring system based on a detector of the invention and arranged at a container.

FIG. 1 shows structural details of a detector 1 of the invention for radiometric measuring systems. Detector 1 can be applied, for example, for fill level measurement or for computer-tomography. Based on its functional principle, detector 1 includes all needed components, in order to produce an electrical evaluation signal sₐ based on incoming, radioactive radiation and showing the power, or intensity, of the incoming radiation. From this, other physical variables can be ascertained, which, in the context of different measuring principles, such as, among others, computer-tomography, are correspondingly information rich. A scintillator 11 of the detector 1 serves, accordingly, to convert incoming, radioactive radiation into optical, or spectrally adjoining, radiation. For this, the scintillator 11 can, on the one hand, operate based on organic scintillator-materials, such as polystyrene or polyvinyl-toluene. On the other hand, inorganic scintillator-materials can be applied, which have, correspondingly, scintillating properties, materials such as thallium-doped sodium iodide or gadolinium-aluminum-gallium-garnet. The optical radiation from the scintillator 11 is converted by a single photodiode 12 or by an array of photodiodes 12 then into an electrical current, which represents the electrical evaluation signal Sa, at least in raw form. In such case, the photodiode 12 is to be so constructed that its band gap corresponds to the scintillator material, thus to the wavelength of the optical radiation.

The detector 1 of the invention is characterized by features including that it is encapsulated by means of construction-and joining technologies known from semiconductor technology. In this way, the detector 1 is populatable on circuit boards and buildable as a separate module, such that corresponding, radiometric measuring systems can be designed compactly and modularly. In such case, in principle, any IC-encapsulation type is suitable, such as THP (“Through Hole Package” or SMD (“Surface Mount Device”).

As illustrated in the case of the embodiment of FIG. 1 is, for IC-conforming encapsulation, on the one hand, the dimensions of the scintillator 11 are in the order of magnitude of the selected semiconductor component comprising the photodiode 12, or the array of photodiodes 12. The means that for a defined contact area with the semiconductor component, the relevant edge lengths of the, for instance, square shaped scintillator 11 correspond maximally to the edge length of the semiconductor component, such as shown schematically in FIG. 1. Essential in the case of this embodiment is that the scintillator 12 covers that region of the semiconductor surface, which is formed by the one or more photodiodes 12. In such case, the scintillator 11 can, both in the case of organic, as well as also inorganic materials, be secured, for example, by means of optically transparent adhesive to the one or more photodiodes 12, such that such are optically coupled with one another.

On the other hand, the height of the scintillator 11 from the photodiode 12 in the embodiment of FIG. 1 is so dimensioned that it is not more than the longest edge length of the semiconductor chip. In this way, the detector 1 can be encapsulated by means of conventional construction-and joining technologies. Accordingly, the encapsulation 14 of the detector 1 of the invention can be designed as any type of IC package. Essential, in such case, is only that the encapsulation material acts optically shieldingly and completely surrounds the scintillator 11 as well as the semiconductor component, in order that the photodiode 12 is protected against stray light. In principle, for example, any potting compound known from the state of the art can be applied for this, wherein to protect against stray light especially black colored plastics are advantageous. Another option, however, is, also, to construct the encapsulation 13 from a ceramic or as a metal housing (“Metal Can Package”).

In the case of the embodiments shown in FIGS. 1 and 2, the detector 1 is encapsulated according to the THP-type (“Through Hole Package”). Accordingly, the semiconductor component, which comprises the photodiodes 12, is arranged on a lead frame 133 and correspondingly connected by bond wires. In such case, one of the pins 131 of the THP-encapsulation functions as electrical output for the evaluating signal Sa.

FIG. 2 shows another embodiment of the detector 1 of the invention, which, with the exception of the encapsulation 13 and the scintillator 11, corresponds to the embodiment shown in FIG. 1. In FIG. 2, the encapsulation 13 is formed by the scintillator 11, or vice versa. For this, the one or more photodiodes 12 are potted with the scintillator material, for example, by means of injection molding or a comparable production method. In such case, a corresponding plastic is applied as scintillator material, for example, polystyrene or polyvinyl-toluene. Advantageous in this case is, on the one hand, that a separate populating of the scintillator 12 is absent. On the other hand, there results from casting the scintillator-material around the semiconductor component automatically an optical coupling between the scintillating encapsulation 11, 13 and the semiconductor component, on which the one or more photodiodes 12 are arranged. For protecting the photodiode 12 against stray light, the scintillator 11, and the encapsulation 13 in the case of this embodiment, must, however, include an optically nontransparent coating 132, for example, in the form of a corresponding painting.

FIG. 3 shows a possible block circuit diagram of the semiconductor component, which monolithically comprises the one or more photodiodes 12. On the one hand, an analog lowpass filter 121 is connected after the one or more photodiodes 12 within the semiconductor component, in order to filter high frequency disturbance fractions from the evaluation signal sₐ, before it is led to the signal-output 131. In this connection, it is, moreover, an option, to amplify and/or digitize the evaluation signal sₐ directly within the semiconductor component. On the other hand, a high voltage-source 123 is moreover integrated monolithically in the semiconductor component, whose block circuit diagram is shown in FIG. 4, in order to supply the photodiodes 12 with the necessary direct voltage of 20-95 V. For this, the high voltage-source 123 can operate, for example, based on a “switched capacitor” principle.

The embodiment of the semiconductor component shown in FIG. 3 includes, additionally, a chip integrated temperature sensor 122. In such case, the temperature value measured by the temperature sensor 122 can be tapped via a separate electrical output 136 of the semiconductor chip, thus a corresponding connection of the detector 1, in order to supply the temperature value to the evaluation unit 6, for example. In this way, the evaluation unit 6 can, in the case of corresponding design, control the high voltage-source 123 in such a manner that the temperature-dependence of the output signal Sa of the photodiode 12 is compensated. For this, the detector 1 includes, for example at a corresponding pin, an electrical input 135 for controlling the high voltage-source 123 and controlled, for example, in turn, by the evaluation unit 6.

The voltage supply of the high voltage-source 123, the temperature sensor 122 and the lowpass filter 121 occurs chip internally via a shared power supply connection to the semiconductor chip, thus to the detector 1. Alternatively to a monolithic integration of the high voltage-source 123, the temperature sensor 121, the lowpass filter filter 121 and the photodiodes 12 in one semiconductor component, the block circuit diagram shown in FIG. 4 can also be implemented by means of hybrid components on a shared circuit board. In such case, the entire circuit board for implementing the idea of the invention is encapsulated according to the “System In Package” principle to, according to which the circuit board, including the components 12, 121, 122, 133 located thereon, is potted.

FIG. 4 illustrates, as possible application of the detector 1 of the invention, a radiometric measuring system for industrial fill level measurement. Accordingly, FIG. 4 shows a container 3 of an industrial process plant. In such case, the container 3 can contain as fill substance 2, for example, crude petroleum, which is undergoing a fractional distillation process. For controlling the process, the fill level L of the fill substance 2 is determined, wherein radiometric fill level measurement is used due to the harsh process conditions. For this, a radiation source 5 of the measuring system is so arranged and oriented that radioactive radiation is issued within a defined beam-cone a toward the container 3. In such case, the radiation source 5 is arranged in the embodiment of FIG. 4 at an upper end region of container 3 and inclined downwards at about 45°. In this way, it is assured that the beam-cone a irradiates the height range of the container interior essential for the fill level-, and/or density profile measuring. Depending on height of the container 3, in given cases depending on which process is running, such height range can be differently high, because of which the measuring system needs, in principle, to be individually adaptable.

Arranged on the opposite side of the container 3 from the radiation source 5 are eleven detectors 11 oriented each with their scintillators 11 toward the container 3, in such a manner that the detectors 1 are distributed vertically with equal separation in the beam-cone a of the radiation source 5 and located in the height range relevant for fill level measurement. In the embodiment shown in FIG. 4, the detectors 1 are surrounded by a shared housing 14, which protects against environmental influences, such as stray optical radiation. In such case, the detectors 1 can be arranged and electrically contacted, for example, on shared a circuit board within the housing 14.

With reference to the measuring system, detectors 1 of the invention enable a constructively simple adapting of the measuring system to different container sizes, since the number of detectors 1 can be modularly expanded. An additional degree of freedom results from the vertical separation between the detectors 1 relative to one another along the container 3. From the vertical, linear arrangement of the detectors 1 in the beam-cone a of the radiation source 5, each detector 1 receives radioactive radiation after its passage through the fill substance 2, or through the gas phase located above such in the container interior. In this way, the intensity of the received radiation—relative to output intensity at the radiation source 5—depends essentially on the fill level L of the fill substance 1 as well as on its density: When, depending on the fill level L, fill substance 2 is located in the beam path between the radiation source 5 and the detector 1, then the intensity of the incoming radiation lessens correspondingly significantly. In such case, the radiation intensity is represented by the evaluation signal sₐ of its detector 1. The reason for this is that the incoming, radioactive radiation is converted within the detectors 1 by means of the scintillators 11, in each case, into optical radiation in the visible, or adjoining UV/IR, regions, and the radiation converted into the optical range by the scintillators 11 is converted by the photodiodes 12 into the electrical evaluation signals sₐ.

In this way, it can be ascertained based on the evaluation signals sₐ of the detectors 1, for example virtually digitally (in such case, each detector 1c corresponds to a digit), from which detector 1, at which container-height, the incoming radiation intensity significantly increases, in order to determine the fill level L therefrom. Alternatively, the fill level L can, for example, also be calculated in the form of an analog, or relative, value, in that the evaluation signals Sa are added, wherein the added value is assignable to an absolute or relative fill level value L, for example, based on a calibration.

Based on the evaluation signals sₐ, it is, moreover, also possible with the arrangement of the detectors 1 shown in FIG. 4 to determine a height dependent density profile of the fill substance 2. In such case, each evaluation signal sₐ represents (for example, based on a calibration) a density value of the fill substance 2. In such case, the evaluation signal Sa of each detector 1 can be associated with a corresponding height along the container 3 (or at least a number of a height dependent sequence 1-11), from which the height dependent density profile results. When only a single density value is to be determined, then the measuring system needs only a single detector 1, in contrast to the embodiment shown in FIG. 4.

In order to determine the density, the density profile, or the fill level L based on the evaluation signals Sa, the measuring system shown in FIG. 4 includes a correspondingly designed evaluation unit 6, which mechanically adjoins the lowest detector 1 in an independent housing part at the corresponding end region of housing 14. In such case, the detectors 1 can be coupled, for example, serially or via a bus system, to the evaluation unit 6, in order to transmit each evaluation signal sₐ, or in order to supply each of the detectors 1 with power. In this connection, the evaluation unit 6 can be designed functionally to register, on the one hand, the number of momentarily connected detectors 1 or their sequence (along the container 3). On the other hand, it is, in such case, advantageous that the evaluation unit 6 sets, or adjusts, the height range, over which the density profile is created, or the fill level L measured, automatically as a function of the number of momentarily connected detectors 1.

On the whole, the radiation source 5 and the detectors 1, or the housing 14, can either be mounted directly to the container 3, or indirectly via freestanding supports. As shown in FIG. 1, the evaluation unit 6 of the measuring system can be connected via a separate interface unit, such as, for instance, “4-20 mA”, “PROFIBUS”, “HART”, or “Ethernet”, to a superordinated unit 4, such as e.g., a local process control system or a decentral server system, for controlling the process. In this way, the measured density-, or fill level value L, can be transmitted, for example, in order to control heating elements or possible supply lines to the container 3. However, also other information concerning general operating state of the measuring system can be communicated.

### LIST OF REFERENCE CHARACTERS

1 detector
2 fill substance
3 container
4 superordinated unit
5 radioactive radiation source
6 evaluation unit
11 scintillator

12 photodiode
13 encapsulation
14 housing
121 analog low-pass filter
122 temperature sensor
123 high voltage-source
131 electrical output for evaluating signal
132 optically nontransparent coating
133 lead frame
134 power supply connection
135 electrical input for controlling the high voltage-source
136 electrical output for the value of the temperature sensor
a beam-cone
L fill level
sₐ evaluation signal

1-12. (canceled)

13. A radiometric detector for a radiometric measuring system, the detector comprising:
a scintillator;
at least one photodiode optically connected with the scintillator, wherein the at least one photodiode is configured to generate an electrical evaluation signal as a function of radioactive radiation intensity entering the scintillator; and
an optically shielding encapsulation configured to shield the scintillator and the at least one photodiode, wherein the encapsulation includes at least one electrical output configured to output the evaluation signal.

14. The detector as claimed in claim 13, wherein the encapsulation and the at least one output are embodied as an integrated circuit (IC) package.

15. The detector as claimed in claim 13, further comprising a plurality of photodiodes.

16. The detector as claimed in claim 13, wherein the encapsulation is formed by the scintillator, and wherein the encapsulation includes an optically nontransparent coating.

17. The detector as claimed in claim 13, wherein the at least one photodiode is embodied as an avalanche-photodiode or as a silicon photomultiplier.

18. The detector as claimed in claim 13, wherein a signal processing unit is connected downstream of the at least one photodiode within the encapsulation, which is configured to amplify, filter, and/or digitize the evaluation signal.

19. The detector as claimed in claim 13, wherein a high voltage converter adapted to supply voltage to the photodiode is arranged within the encapsulation.

20. The detector as claimed in claim 13, wherein a temperature sensor is arranged within the encapsulation.

21. The detector as claimed in claim 18, wherein the signal processing unit, the high voltage source, and/or the temperature sensor are/is an integral component of the semiconductor chip.

22. A radiometric measuring system for determining density and/or fill level of a fill substance in a container, the measuring system comprising:
a radioactive radiation source arrangeable relative to the container such that radioactive radiation is transmitted within a beam-cone toward the container,
at least one detector as claimed in claim 13, arranged on the opposite side of the container from the radiation source such that the scintillator is located, at least partially, in the beam-cone, and
an evaluation unit connected to the at least one detector and embodied to determine a density, a density profile, or a fill level of the fill substance based on the evaluation signal.

23. The measuring system as claimed in claim 22, comprising a plurality of detectors as claimed in claim 13, arranged vertically aligned above one another at the container.

24. A computer-tomograph, comprising an array of detectors as claimed in claim 13.

25. The detector as claimed in claim 13, wherein the electrical evaluation signal is processed by a signal processing unit, wherein the signal processing unit is configured to amplify, filter, and/or digitize the evaluation signal.

26. The detector as claimed in claim 14, wherein the plurality of photodiodes is arranged as an array.

27. The detector as claimed in claim 20, wherein the temperature sensor controls the high voltage source.
